(19) United States
(12) Patent Application Publication
(10) Pub. No.: US 2017/0293452 A1
(43) Pub. Date: Oct. 12, 2017

(54) STORAGE APPARATUS

(71) Applicant: Hitachi, Ltd., Tokyo (JP)

(72) Inventors: Mitsuo HAYASAKA, Tokyo (JP); Kazumasa MATSUBARA, Tokyo (JP)

(21) Appl. No.: 15/508,125

(22) PCT Filed: Nov. 28, 2014
(86) PCT No.: PCT/JP2014/081554

§ 371 Date: Mar. 2, 2017

(51) Int. Cl. G06F 3/06

(52) U.S. Cl. CPC G06F 3/0661; G06F 3/0608; G06F 3/0641; G06F 3/0683

(57) ABSTRACT

A storage apparatus includes a controller configured to carry out data processing for content that is received, and a media area configured to store the content for which the data processing has been carried out. The controller is configured to classify segments in the content and carry out data rearrangement processing of assembling segments of the same type in the classified segments. The controller is configured to carry out data amount reduction processing for the content for which the data rearrangement processing has been carried out, and store in the media area the content for which the data amount reduction processing has been carried out.

### BACKGROUND

This invention relates to a storage apparatus.

When data is stored in a medium, a data amount is reduced for its storage in order to decrease a cost of the medium. For example, file compression contracts data segments having the same content in one file, thereby reducing the data amount. Deduplication contracts data segments having the same content not only in one file but also among files, thereby reducing a total amount of data in a file system and a storage apparatus.

In Patent Literature 1, there are disclosed a method involving detecting elements constructing content and applying deduplication to the elements on an element-by-element basis, and a method involving compressing non-redundant data after the deduplication is applied.

Patent Literature 1: US 2011/0125719 A 1

### SUMMARY

In Patent Literature 1, metadata for storing, for example, information on a header, a data arrangement, and a font, and body data, both of which construct a file, are extracted on an element-by-element basis, and deduplication and compression are applied to each element.

However, the header and the metadata have small sizes, and store information such as a date and a time. Thus, there is hardly any or almost no effect of the deduplication. In the method disclosed in Patent Literature 1, metadata (for example, fingerprint) for the deduplication needs to be generated for such data. Therefore, the metadata for the deduplication increases, and the effect of deduplication decreases. Further, a decrease in usage efficiency of a memory area causes a frequent I/O to a media area, resulting in a decrease in performance.

Moreover, in Patent Literature 1, the compression processing is sequentially applied from the head of the non-redundant data after the application of the deduplication. The non-redundant data has different types of data patterns, and hence the effect of compression decreases.

A representative example of this invention is a storage apparatus, including: a controller configured to carry out data processing for content that is received; and a media area configured to store the content for which the data processing has been carried out, wherein the controller is configured to: classify segments in the content; carry out data rearrangement processing of assembling segments of the same type in the classified segments; carry out data amount reduction processing for the content for which the data rearrangement processing has been carried out; and store in the media area the content for which the data amount reduction processing has been carried out.

According to an embodiment of this invention, the data storage amount in the media area can effectively be reduced.

### BRIEF DESCRIPTION OF THE DRAWINGS

FIG. 1 is a diagram for schematically illustrating a first embodiment of this invention.

FIG. 2 is a diagram for illustrating a hardware configuration example of a file storage apparatus.

FIG. 3 is a diagram for illustrating a configuration example of content processing information.

FIG. 4A is a diagram for illustrating a content example of the content type A.

FIG. 4B is a diagram for illustrating a content example of the content type B.

FIG. 4C is a diagram for illustrating a content example of the content type C.

FIG. 4D is a diagram for illustrating a content example of the content type D.

FIG. 4E is a diagram for illustrating a content example of the content type E.

FIG. 5A is a diagram for illustrating a content after rearrangement of a content of the content type C by a data rearrangement program.

FIG. 5B is a diagram for illustrating a content D′ after rearrangement of a content of the content type D by the data rearrangement program.

FIG. 5C is a diagram for illustrating a content D′ after rearrangement of a content of the content type D by the data rearrangement program.

FIG. 5D is a diagram for illustrating a content E′1 after rearrangement of a content of the content type E by the data rearrangement program.

FIG. 5E is a diagram for illustrating a content E′2 after rearrangement of a content of the content type E by the data rearrangement program.

FIG. 5F is a diagram for illustrating a content E′3 after rearrangement of a content of the content type E by the data rearrangement program.

FIG. 6 is a diagram for illustrating a configuration example of a file recipe.

FIG. 7 is a flowchart for illustrating an outline of processing carried out for content by the file storage apparatus.

FIG. 8 is a flowchart for illustrating in detail Step 874 of the flowchart illustrated in FIG. 7, namely, the processing for the content whose content type is D.

FIG. 9 is a flowchart for describing in detail Step 875 illustrated in FIG. 7, namely, the processing for the content whose content type is E.

FIG. 10 is a flowchart for illustrating content read processing.

FIG. 11 is a diagram for schematically illustrating a second embodiment.

FIG. 12 is a diagram for illustrating a hardware configuration example of a file storage head and a block storage apparatus.

FIG. 13 is a diagram for illustrating an example of the content processing instruction.

### DETAILED DESCRIPTION OF THE EMBODIMENTS

Referring to the accompanying drawings, a description is given of some embodiments of this invention. The embodiments described herein do not limit the invention as defined in the appended claims, and not all of components described in the embodiments and combinations thereof are always indispensable for solutions of this invention.

In the following description, various types of information are sometimes described as an expression “XX table”, but the various types of information may be expressed as data structure other than a table. In order to indicate that the information is independent of the data structure, “XX table” may be referred to as “XX information”.

In the following description, in some cases, a description is given of processing with a program expressed as a subject, but the program is executed by hardware itself or a processor (for example, microprocessor (MP)) included in the hardware to carry out defined processing while appropriately using storage resources (for example, a memory) and/or communication interface devices (for example, a port). Therefore, the subject of the processing may be the hardware or the processor. A program source may be, for example, a program distribution server or a storage medium.

In the following, a technology for reducing a data amount in a storage apparatus is disclosed. The storage apparatus includes one or more storage devices for storing data. In the following, a storage area provided by the one or more storage devices is referred to as “media area”. The storage device is, for example, a hard disk drive (HDD), a solid state drive (SSD), and a RAID constructed by a plurality of drives.

The storage apparatus is configured to manage data for each piece of content, which is logically assembled data. Moreover, access to data is made to each piece of content. As the content, in addition to an ordinary file, there are given an archive file, a backup file, and a volume file of a virtual computer, which are files constructed by assembling the ordinary files. The content may be a part of a file.

The storage apparatus according to this embodiment is configured to carry out, when content is received, rearrangement processing for data in the content, thereby changing data structure of the content. Specifically, the storage apparatus is configured to classify segments in the content to assemble segments of the same type. The segment is a group of meaningful data in the content.

The data rearrangement processing changes a segment sequence in the content, resulting in generation of content having new data structure. In the content having the new data structure, the assembled plurality of segments are continuously arranged.

The storage apparatus is configured to carry out the data amount reduction processing for the content whose data structure has been changed by the data rearrangement processing. The data amount of the content can efficiently be reduced by carrying out the data amount reduction processing after the data rearrangement processing.

In one example, the storage apparatus determines a data reduction method for each segment. The storage apparatus identifies the segment type of each segment after the rearrangement, and carries out the data reduction processing in accordance with the data amount reduction method associated with the segment type in advance.

The data amount reduction processing includes, for example, only deduplication, only compression, or both the deduplication and the compression. The data amount reduction processing may not be applied to a part of the segment types. The data amount reduction method is determined for each segment type, and the data amount can thus appropriately be reduced in accordance with the segment type.

### First Embodiment

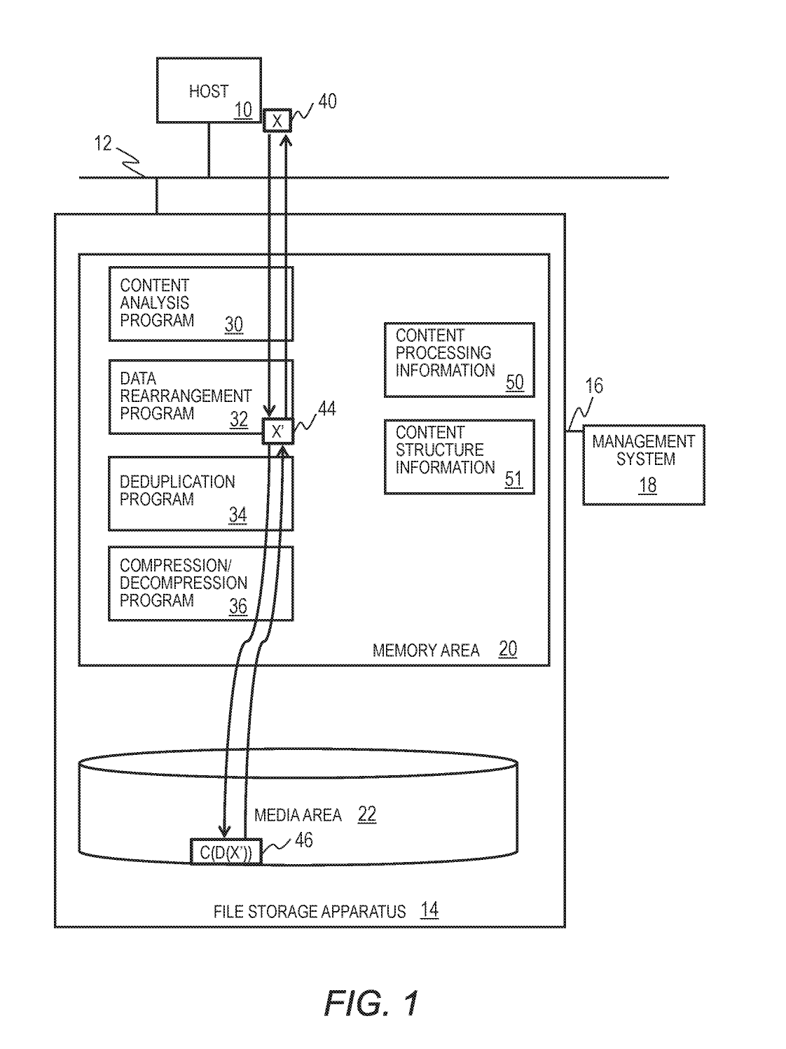

FIG. 1 is a diagram for schematically illustrating a first embodiment of this invention. A memory area 20 of a file storage apparatus 14 stores a content analysis program 30, a data rearrangement program 32, a deduplication program 34, and a compression/decompression program 36. The memory area 20 further stores content processing information 50 and content structure information 51. The content processing information 50 indicates information on a data amount reduction method for each content type. The content structure information 51 indicates information on content structure for each content type. The information on the content structure indicates, for example, information on a header portion.

A host 10 transmits to the file storage apparatus 14 via a network 12 a content X 40 together with an update request. The content analysis program 30 analyzes the content X 40. Specifically, the content analysis program 30 refers to management information contained in the content X 40, thereby identifying the type of the content X 40. The content analysis program 30 classifies segments in the content X 40 based on this content type and the content structure information 51.

The data rearrangement program 32 carries out the data rearrangement processing for the content X 40 in accordance with an analysis result obtained by the content analysis program 30 and the content processing information 50. The data rearrangement program 32 assembles segments of the same type. As a result, the data rearrangement program 32 generates a content X′ 44 having data structure different from that of the content X 40.

More specifically, the data rearrangement program 32 assembles a plurality of segments of the same type into an assembled segment group, and couples the respective assembled segment groups to remaining non-assembled segments (if any exist). As a result, the content X 40 changes to the content X′ 44 having different data structure.

The deduplication program 34 and the compression/decompression program 36 respectively carry out deduplication processing and compression processing required for the content X′ 44 based on the content processing information 50. The content processing information 50 indicates data reduction methods for the content type of the content X′ 44.

As described later, the content processing information 50 prescribes the data reduction method for each segment type. The deduplication program 34 and the compression/decompression program 36 refer to the content processing information 50 to respectively carry out the deduplication processing and the compression processing in accordance with the types of the content X′ 44.

The content X′ 44 changes to a content C(D(X′)) 46 as a result of the application of the deduplication processing and the compression processing. The content C(D(X′)) 46 is stored in a media area 22. The media area 22 is a storage area provided by a storage device.

When the host 10 transmits a reference request for the content X 40 to the storage apparatus 14 via the network 12, the content C(D((X′)) 46 is read from the media area 22. The compression/decompression program 36 and the deduplication program 34 rearrange the content X′ 44.

Specifically, the compression/decompression program 36 carry out decompression processing for the content C(D((X′)) 46. The deduplication program 34 acquires the structure data removed from the content X′ 44 from the content and the media area 22, and adds the structure data.

The data rearrangement program 32 restores the content X′ 44 to the content X 40 before the data rearrangement processing. The reconstructed content X 40 is transferred to the host 10 via the network 12.

According to this embodiment, the deduplication processing and the compression procession can be applied to the data for which those pieces of processing are effective in the content, thereby increasing the data amount reduction effect. As a result, a data amount to be stored can efficiently be reduced when the data amount is increased in big data analysis or the like.

According to this embodiment, the file storage apparatus can automatically reduce the data amount of the content, and a load imposed on an administrator can thus be decreased, resulting in a decrease in management cost. In particular, in a cloud service, a storage capacity required to provide a service decreases, and a cloud vendor can provide a user with storage excellent in cost performance.

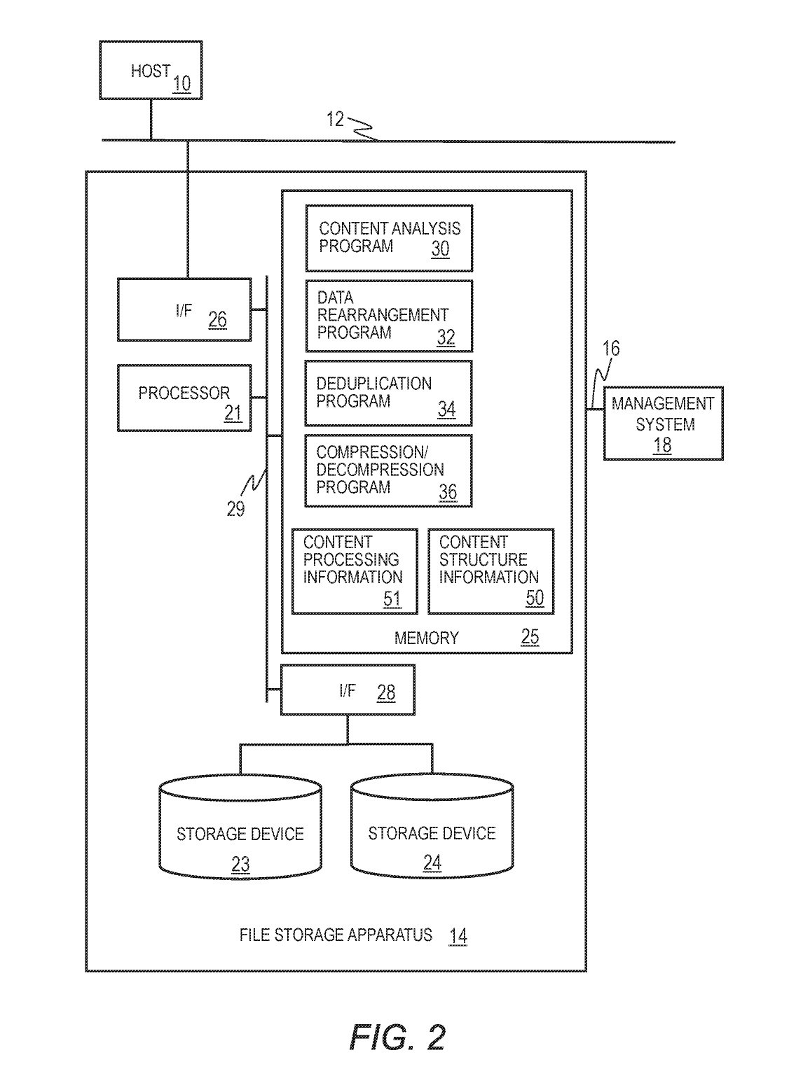

FIG. 2 is a diagram for illustrating a hardware configuration example of the file storage apparatus 14. The file storage apparatus 14 is coupled to a management system 18 via a management network 16. The file storage apparatus 14 is coupled to one or more hosts 10 via a data network 12. The host 10 is, for example, a server computer.

The management system 18 is constructed by one or more computers. The management system 18 includes, for example, a server computer, and a terminal for accessing this server computer via a network. The administrator manages and controls the file storage apparatus 14 via a display device and an input device of the terminal.

The management network 16 and the data network 12 are each, for example, a wide area network (WAN), a local area network (LAN), the Internet, a storage area network (SAN), a public line, or a dedicated line. The management network 16 and the data network 12 may be the same network.

The file storage apparatus 14 includes a processor 21, a memory 25, a storage device interface 28, storage devices 23 and 24, and a network interface 26. The devices in the file storage apparatus 14 are coupled to one another for communication via a system bus 29. The processor 21 and the memory 25 are examples of a controller of the file storage apparatus 14. At least a part of functions of the processor 21 may be implemented by other logic circuits.

Referring again to FIG. 1, the memory 25 stores the content analysis program 30, the data rearrangement program 32, the deduplication program 34, and the compression/decompression program 36. The memory 25 further stores the content processing information 50. Data stored in the memory is typically loaded from the storage devices 23 and 24. The storage devices 23 and 24 are each, for example, an HDD, an SSD, and a RAID.

The memory 25 is used to store information read from the storage devices 23 and 24, and is also used as a cache memory for temporarily storing data received from the host apparatus 10. The memory 25 is further used as a work memory for the processor 21.

As the memory 25, a volatile memory, for example, a DRAM, and a nonvolatile memory, for example, a flash memory, is used. In the memory 25, data can be read and written faster than in the storage devices 23 and 24.

The content processing information 50 indicates the data amount reduction processing method for each piece of content. The management system 18 is configured to set the content processing information 50 and the content structure information 51. The content structure information 51 stores information on data structure for each piece of content. A description is later given of the content data structure through use of examples.

The processor 21 is configured to operate in accordance with programs, calculation parameters, and the like stored in the memory 25. The processor 21 is configured to operate in accordance with the program, thereby operating as a specific functional module. For example, the processor 21 carries out content analysis processing in accordance with the content analysis program 30. Similarly, the processor 21 carries out data rearrangement processing, deduplication processing, and compression/decompression processing in accordance with the data rearrangement program 32, the deduplication program 34, and the compression/decompression program 36, respectively.

The content analysis program 30 analyzes content stored in the file storage apparatus 14. The data rearrangement program 32 refers to the analysis result obtained by the content analysis program 30 to carry out the data rearrangement processing for the content.

Specifically, the content analysis program 30 assembles segments constructing content on a segment-by-segment basis. The data rearrangement program 32 couples the assembled segment groups constructed by assembling the plurality of segments, and remaining segments that have not been assembled to one another.

The deduplication program 34 searches the content and the media area 22 for blocks (blocks having the same data) redundant with a subject block in the content, and when redundant blocks exist, converts the subject block to a pointer representing each redundant block. The subject block in the content is not stored in the media area 22. The compression/decompression program 36 compresses and decompresses the data in the content. The sequence of the deduplication processing and the compression processing may be inverted.

The storage device 23 is configured to provide an area for temporarily storing content received by the file storage apparatus 14 from the host 10. The processor 21 may be configured to asynchronously read out the content stored in the storage device 23, and then carry out the content analysis processing, the deduplication processing, and the compression processing. The processor 21 is configured to apply the data reduction to the content, and then store the content in the storage device 24. The storage device 24 provides the media area 22. The memory 25 may hold the received content, and the storage device 23 may be omitted.

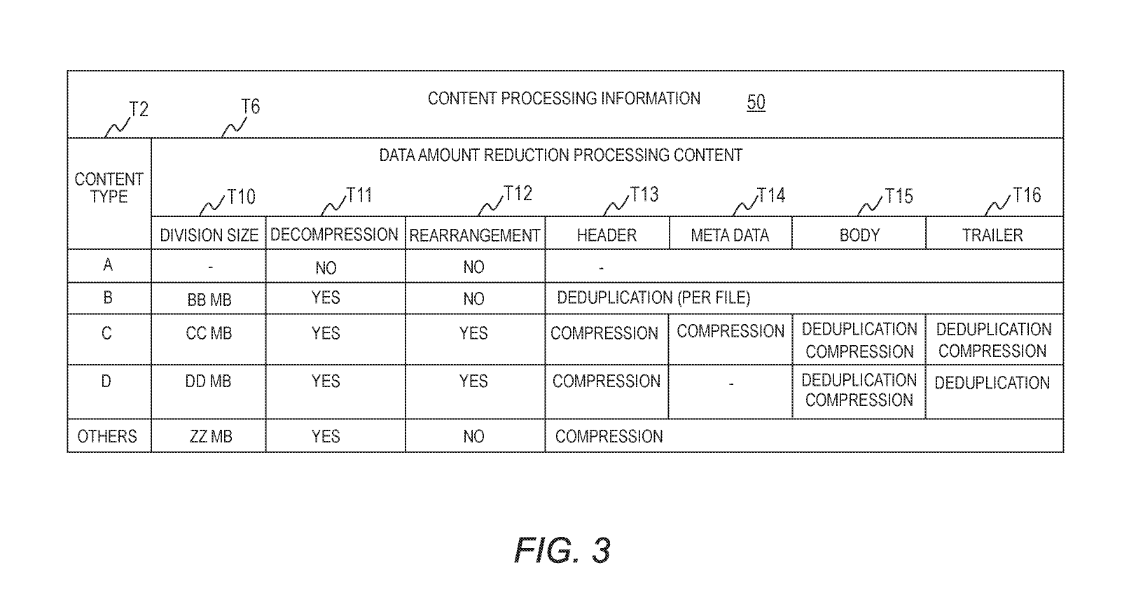

FIG. 3 is a diagram for illustrating a configuration example of the content processing information 50. The content processing information 50 of this example has table structure. The content processing information 50 describes the data amount reduction method for each piece of content. As a result, data amount reduction effective for each content type is implemented. The data reduction method for each piece of content indicates the data reduction method for each segment type. As a result, the data amount reduction effective for each segment type is implemented. In the management system 18, the content processing information 50 is generated and stored in the file storage apparatus 14. A user can use the content processing information 50 to specify a processing method for each content type.

The content processing information 50 includes a content type column T2 and a data amount reduction processing content column T6. Further, the data amount reduction processing content column T6 includes a division size column T10, a decompression column T11, a rearrangement column T12, a header column T13, a metadata column T14, a body column T15, and a trailer column T16.

The division size column T10 indicates a size when content is divided before the data rearrangement processing. Each portion divided in accordance with the division size is a unit to which subsequent processing is to be applied. For example, the data rearrangement program 32 carries out the data rearrangement in each divided portion. The processor 21 divides content having a content size larger than a threshold into portions having a size indicated by the division size column T10 of the corresponding content type, and further carries out the data rearrangement processing and the data amount reduction processing for each divided portion. As a result, processing speeds of the data rearrangement processing and the data amount reduction processing are increased.

The decompression column T11 indicates whether or not content to which compression processing has been applied is to be decompressed before the data amount reduction processing for the content. More effective data amount reduction can be implemented by decompressing the compressed content before the data rearrangement processing and the data amount reduction processing.

The rearrangement column T12 indicates whether or not the data rearrangement is to be carried out in the content before the data amount reduction processing for the content. When the rearrangement column T12 indicates that the data rearrangement is to be carried out, the data rearrangement program 32 assembles segments of the same type in the content.

The header column T13 to the trailer column T16 respectively indicate data amount reduction methods for the corresponding segment types. The header column T13 indicates the data reduction method for a header in the content. The metadata column T14 indicates the data reduction method for metadata in the content. The body column T15 indicates the data reduction method for a body in the content. The trailer column T16 indicates the data reduction method for a trailer in the content.

In this example, the data amount reduction processing content column T6 indicates four data amount reduction methods applicable to subject data. Of the four methods, one method carries out both the deduplication processing and the compression processing, one method carries out only the deduplication processing, one method carries out only the compression processing, and one method does not carry out the data amount reduction processing.

For example, content whose content type is “D” is divided into portions having a division size DD (MB). The data rearrangement processing is applied to the content whose content type is “D”, and further, only the compression processing is applied to the header segment. Similarly, the deduplication and the compression are applied to the body segment, and the deduplication is applied to the trailer segment. Moreover, only the deduplication processing per file is applied to the content whose content type is “B”.

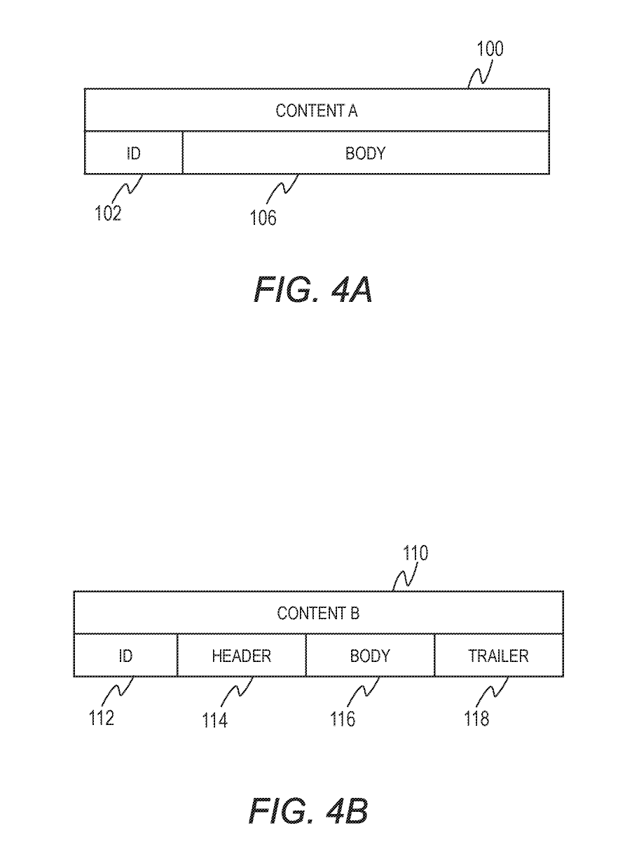

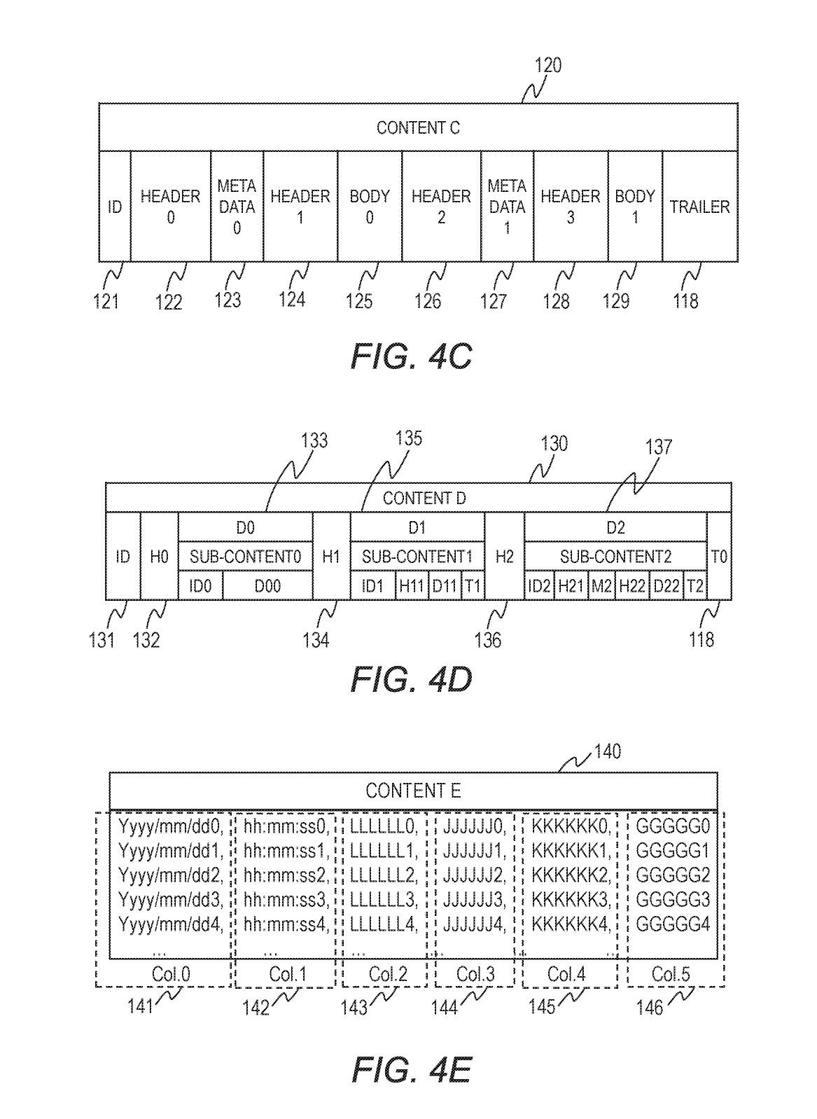

FIG. 4A to FIG. 4E are respectively illustrations of examples of the content. There is no structure common to all the types of content stored in the file storage apparatus 14. When specific data exists in a specific position of content, and the file storage apparatus 14 for processing the content knows of its existence, the structure of the content is defined.

In other words, even when characteristic data exists in content but the file storage apparatus 14 does not recognize its existence, such a state is equivalent in meaning to a state where the content does not have structure. In this example, only a content type for which the content structure information 51 indicates content structure has content structure.

For example, the content structure information 51 indicates structure information on each content type. For example, the content structure information indicates a position of the header portion in the content, a size, and format information for reading the header portion, as well as format information for reading other management segments of the content. The management segments are segments other than the body portion.

FIG. 4A is a diagram for illustrating a content 100, which is a content example of the content type A. The content A (100) is constructed by a content ID portion 102 and a body portion 106, which does not substantially have structure. Those portions are segments. The content ID portion 102 indicates the content type and an application that has generated the content.

The content ID portion 102 is also referred to as “magic number”, and generally exists at the head of the content. As another example of the content of the content type A, there exists content that does not include the content ID portion and does not have any structure. The content analysis program 30 handles the content ID portion 102 and the body portion 106 together in the content of the content type A.

FIG. 4B is a diagram for illustrating a content 110 of the content type B. The content B (110) is constructed by a content ID portion 112, a header portion 114, a body portion 116, and a trailer portion 118. Those portions are segments.

The header portion 114 describes the structure of the content, and is arranged in the vicinity of the head of the content. The content analysis program 30 refers to the content structure information 51, and can thus recognize the position of the header portion 114 in the content 110, the size, and how to read the header portion 114 based on the content type.

The header portion 114 indicates structure information on other segments. The content analysis program 30 analyzes the header portion 114 to recognize the positions of the body portion 116 and the trailer portion 118 in the content 110 and the sizes thereof. The content analysis program 30 acquires detailed information on components of the body portion 116 and the positions of the components from the header portion 114. The content ID portion 112 and the header portion 114 may be considered as one segment. The header portion 114 may include information on the position and the size of the header portion 114.

The trailer portion 118 is arranged at the end of the content 110, and information stored therein varies. For example, the trailer portion 118 includes information on the entire content 110, for example, the content size, and can be used to check correctness of content processing or the like. The trailer portion 118 may include padding data, which is logically meaningless.

FIG. 4C is a diagram for illustrating a content 120, which is a content example of the content type C. The content C (120) is constructed by a content ID portion (121), a header portion 0 (122), a metadata portion 0 (123), a header portion 1 (124), a body portion 0 (125), a header portion 2 (126), a metadata portion 1 (127), a header portion 3 (128), a body portion 1 (129), and the trailer portion (118). Those portions are segments.

In the content C (120), one or more header portions include information for coupling one or more metadata portions and one or more body portions to one another as one content. In other words, the header portion 0 (122), and the header portion 1 to the header portion 3 indicate information for coupling the metadata portion 0, the metadata portion 1, the body portion 0, and the body portion 1 as one content.

The header portion indicates, for example, structure information on subsequent segments up to a next header portion. The header portion may indicate structure information on the entire segments in the content. Each header portion may include information on the type, the position, and the size of the own segment. Each header portion may indicate structure information on entire subsequent segments.

For example, the content structure information 51 indicates the structure information on the header portion 0 (122). The header portion 0 (122) indicates the positions and the sizes of the metadata portion 0 (123) and the next header portion 1 (124).

The header portion 1 (124) indicates the types, the positions, and the sizes of the body portion 1 (125) and the next header portion 2 (126). The header portion 2 (126) indicates the types, the positions, and the sizes of the metadata portion 1 (127) and the next header portion 3 (128). The header portion 3 (128) indicates the types, the positions, and the sizes of the body portion 2 (129) and a trailer portion 118.

The body portion 0 (125) and the body portion 1 (129) store user data. The metadata portion 0 (123) and the metadata portion 1 (127) respectively store the positions of data stored in the body portion 0 (125) and the body portion 1 (129) in the body portion, font information, and the like.

FIG. 4D is a diagram for illustrating a content 130, which is a content example of the content type D. The content 130 is constructed by a content ID portion (131), a header portion H0 (132), a header portion H1 (134), a header portion H2 (136), a body portion D0 (133), a body portion D1 (135), a body portion D2 (137) and a trailer portion T0 (118).

In the example of FIG. 4D, the body portions D0 (133), D1 (135), and D2 (137) include one or more sub-contents. In FIG. 4D, the body portion D0 (133) is a sub-content 0, the body portion D1 (135) is a sub-content 1, and the body portion D2 (137) is a sub-content 2.

The header portion H0 (132), the header portion H1 (134), and the header portion H2 (136) indicate information for coupling the body portion D0 (133), the body portion D1 (135), the body portion D2 (137), and the trailer portion T0 (118) to one another as one content.

A description of the information indicated by the header portions of the content D (130) is the same as that of the content C (120) illustrated in FIG. 4C. For example, the header portion H0 (132), the header portion H1 (134), and the header portion H2 (136) respectively indicate the structure information on the respective segments up to the next header portions. The information on the type of the body portion in the header portion indicates that the body portion is the sub-content.

The sub-content may include a header portion, a body portion, a metadata portion, and the like. The header portion in the sub-content indicates information on internal structure of the sub-content, and includes information for coupling the other segments in the sub-content to one another as one sub-content. In this structure, the body portion, which is the sub-content, is constructed by a plurality of segments.

In the example of FIG. 4D, the content structures of the sub-contents 0, 1, and 2 are respectively the same as those of the content A (100), the content B (110), and the content C (120). In other words, the content types respectively indicated by the content IDs of the sub-contents 0, 1, and 2 match the content types of the content A (100), the content B (110), and the content C (120). The content analysis program 30 analyzes the sub-content in accordance with the content type indicated by the content ID portion of the sub-content.

The above-mentioned sub-content structure is generated, for example, when the content D (130) is an archive file unifying the sub-content 0, the sub-content 1, and the sub-content 2. In addition, a backup file, a virtual disk volume, and a rich media file may have such structure.

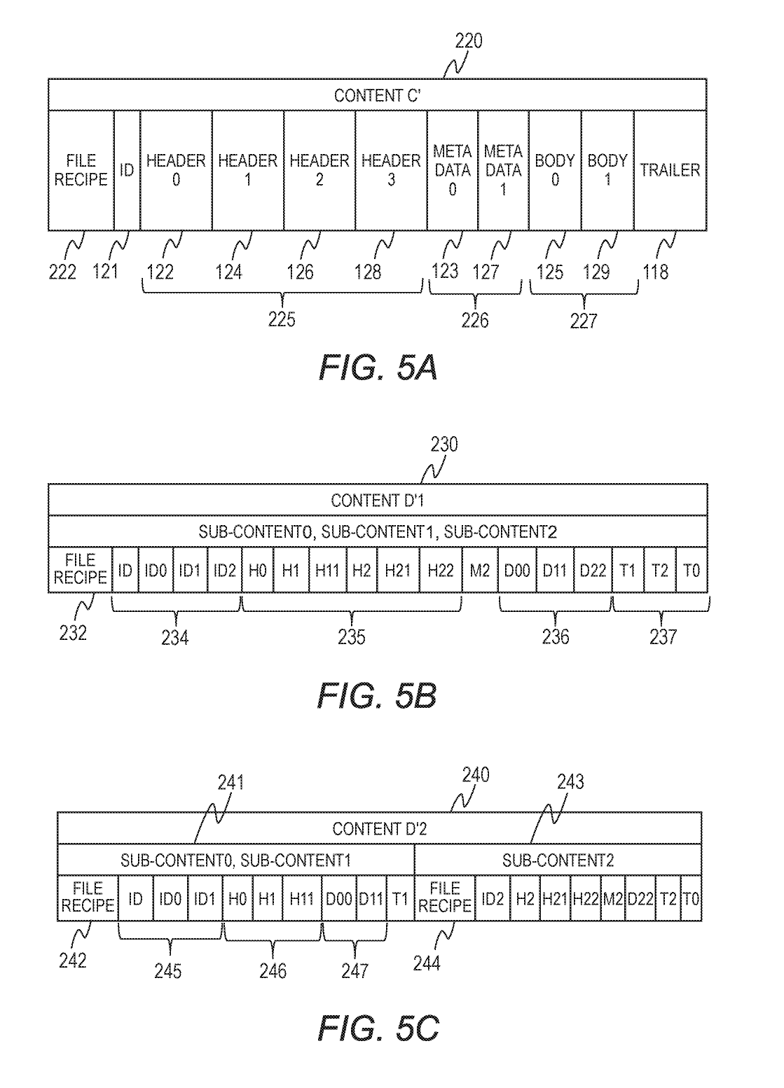

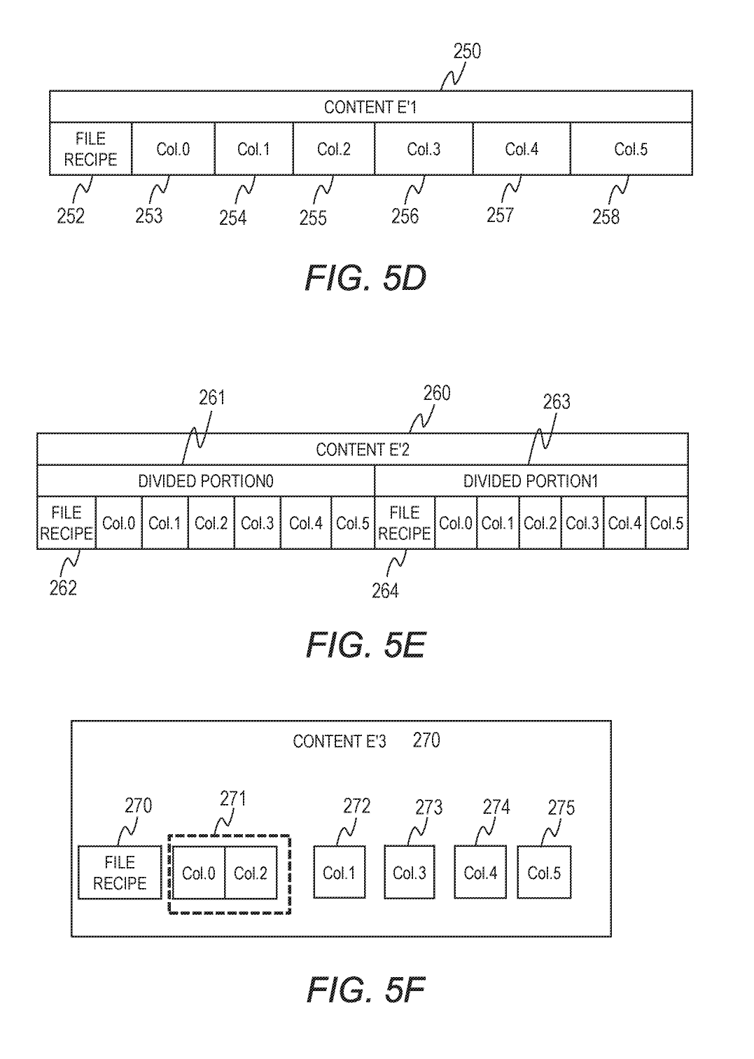

FIG. 4E is a diagram for illustrating a content 140, which is a content example of the content type E. The content 140 is content written in accordance with a specific rule, and is, for example, a log file. Columns Col. 0 (141) to Col. 5 (146) are respectively sets of values of the same data type separated by a separator character (for example, a comma or a tab). The data type is, for example, a date and a time. In FIG. 4E, a part of data including the content ID portion is omitted. The same applies to FIG. 5D to FIG. 5F.

In a data arrangement of the content 140, rows are coupled to one another in a sequence from a top row to a bottom row. Each value specified by the column and the row is a segment, and the column is a set of segments of the same segment type. Different segment types are defined for the respective columns.

FIG. 5A is a diagram for illustrating a content 220 after the rearrangement of the content 120 of the content type C by the data rearrangement program 32. The data rearrangement program 32 assembles the header portions 122, 124, 126, and 128 to generate one assembled segment group 225. Similarly, the data rearrangement program 32 assembles the metadata portions 123 and 127 to generate one assembled segment group 226, and assembles the body portions 125 and 129 to generate one assembled segment group 227.

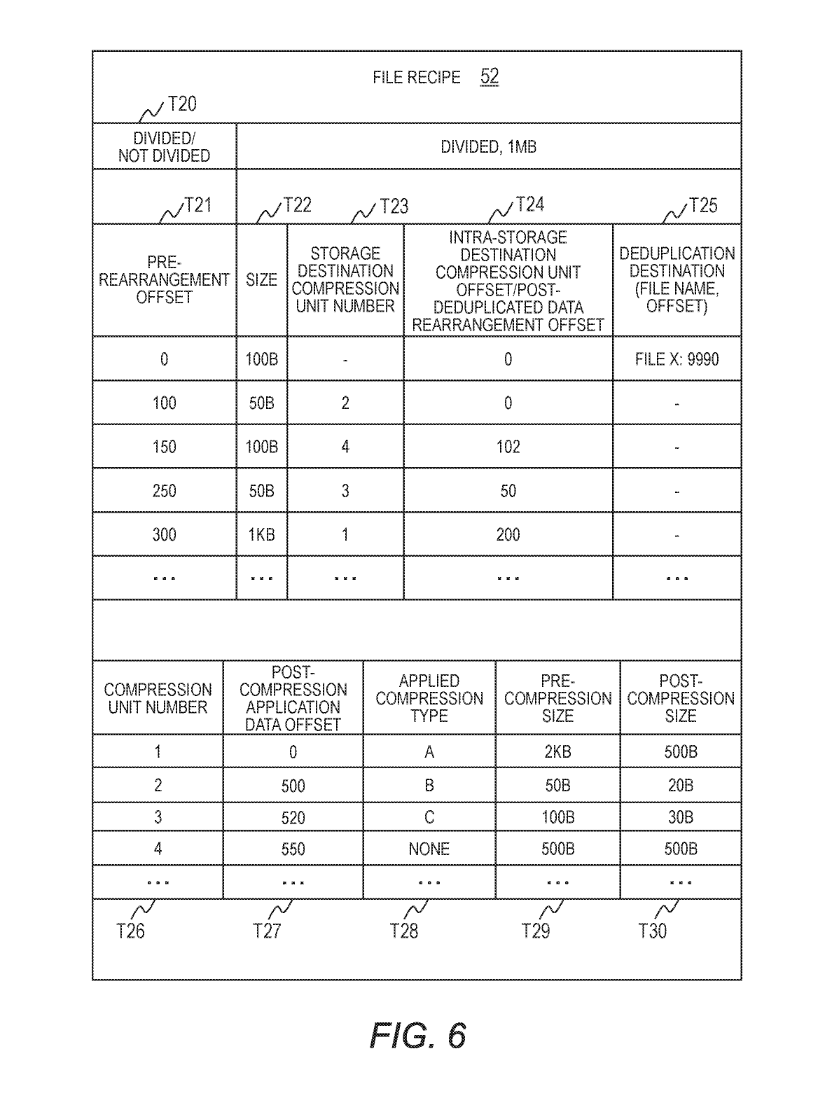

The data rearrangement program 32 couples the content ID portion 121 and the trailer portion 118, which are the segments not assembled, and the assembled segment groups 255 to 257 to one another. Further, the data rearrangement program 32 generates a file recipe 222, and adds the file recipe 222 to the head of a content C′ (220) after the rearrangement. The file recipe 222 indicates a relationship between offsets in the content C′ (220) after the rearrangement and the content 120 before the rearrangement. Referring to FIG. 6, a description is later given of the file recipe.

FIG. 5B is a diagram for illustrating a content D′ 1 (230) after the rearrangement of the content 130 of the content type D by the data rearrangement program 32. The data rearrangement program 32 carries out the rearrangement of the content 130 without dividing the content 130. The content D′1 (230) after the rearrangement includes a file recipe 232 at the head and subsequent coupled segments similarly to the content C′ (220).

The type of the segments assembled into an assembled segment group 234 is the content ID. Specifically, the assembled segment group 234 is constructed by the content ID portion 131 of the content 130 and the content ID portions of the sub-contents 133, 135, and 137. The content ID portion of the content 130 and the content ID portions of the sub-contents 133, 135, and 137 may be defined so as to belong to different segment types.

The type of the segments assembled into an assembled segment group 235 is the header. Specifically, the assembled segment group 235 is constructed by the header portions 132, 134, and 136 of the sub-contents 133, 135, and 137 and the header portions of the sub-contents 135 and 137. The header portion outside the sub-content and the header portion in the sub-content may be defined so as to belong to different segment types.

The segment type assembled into an assembled segment group 236 is the body. The assembled segment group 236 is constructed by the body portions in the sub-contents 133, 135, and 137. The body portion is denoted by D. The segment type assembled into an assembled segment group 237 is the trailer. The assembled segment group 237 is constructed by the trailer portions of the sub-contents 133, 135, and 137, and the trailer portion 118 of the content 130 before the rearrangement. The trailer portions of the sub-contents and the trailer portion of the content may be defined so as to belong to different segment types.

FIG. 5C is a diagram for illustrating a content D′2 (240) after the rearrangement of the content 130 of the content type D by the data rearrangement program 32. The data rearrangement program 32 divides the content 130 into divided portions having the division size indicated by the division size column T10 in the content processing information 50, and carries out the data rearrangement processing for each divided portion. In the example of FIG. 5C, the ID portion (131), the header portion H0 (132), the sub-content 0 (133), the header portion H1 (134), and the sub-content 1 (135) are included in one divided portion. The sub-content 2 (137) and the trailer portion T0 (118) are included in another divided portion.

The data rearrangement program 32 generates file recipes 242 and 244 for the respective divided portions, and adds the file recipes 242 and 244 to respective heads of divided portions 241 and 243 after the rearrangement. The file recipe is generated and assigned for each unit data after the data rearrangement, and the structure of the content can thus appropriately be restored to the original structure.

For example, in the divided portion 241 after the rearrangement, the segment type of the assembled segment group 245 is the ID, and the assembled segment group 245 is constructed by the content ID portion 131, a content ID portion ID0 of the sub-content 0 (133), and a content ID portion ID1 of the sub-content 1 (135).

For example, the segment type of an assembled segment group 246 is the header, and the assembled segment group 246 is constructed by the header portion H0 (132), the header portion H1 (134), and a header portion H11 of the sub-content 1 (135). The segment type of an assembled segment group 247 is the body, and the assembled segment group 247 is constructed by a body portion D00 of the sub-content 0 (133) and a body portion D11 of the sub-content 1 (135).

FIG. 5D is a diagram for illustrating a content E′1 (250) after the rearrangement of the content 140 of the content type E by the data rearrangement program 32. The data rearrangement program 32 carries out the rearrangement of the content 140 without dividing the content 140. The content E′1 (250) after the rearrangement includes a file recipe 252 at the head and subsequent coupled segments.

The type of the segments assembled into an assembled segment group 253 is the column Col. 1. The assembled segment group 253 is constructed by the values included in the column Col. 1 of the content 140. Similarly, the types of the segments respectively assembled into assembled segment groups 254 to 258 are the column Col. 2 to the column Col. 5. The content processing information 50 for the content type E prescribes the data amount reduction method for each column, which is different from the example illustrated in FIG. 3.

FIG. 5E is a diagram for illustrating a content E′2 (260) after the rearrangement of the content 140 of the content type E by the data rearrangement program 32. The data rearrangement program 32 divides the content 140 into divided portions having the division size indicated by the division size column T10 in the content processing information 50, and carries out the data rearrangement processing for each divided portion.

The data rearrangement program 32 generates file recipes 262 and 264 for the respective divided portions, and adds the file recipes 262 and 264 to respective heads of divided portions 261 and 263 after the rearrangement. The divided portions 261 and 263 after the rearrangement respectively include data of parts of the column Col. 0 (141) to the column Col. 5 (146). In the divided portions 261 and 263, the values (segments) in the same column are assembled and continuously arranged.

FIG. 5F is a diagram for illustrating a content E′3 (270) after the rearrangement of the content 140 of the content type E by the data rearrangement program 32. The content E′3 (270) includes a plurality of files 271 to 275. The data rearrangement program 32 generates one file recipe 270 common to the files 271 to 275 of the content E′3 (270). The file 271 is constructed by an assembled segment group of the column Col. 0 (141) and an assembled segment group of the column Col. 2 (143). The other files 272 to 275 are each an assembled segment group for one column. The data amount reduction processing is carried out for each file. Assembled segment groups having high data amount reduction efficiency are assembled into one file.

FIG. 6 is a diagram for illustrating a configuration example of a file recipe 52. The file recipe 52 indicates a relationship among data positions between before and after the rearrangement. The data rearrangement program 32 can convert content from structure after the rearrangement to structure before the rearrangement in accordance with the file recipe. In this example, the file recipe further includes information on the data reduction processing. As a result, content for which the data reduction processing has been carried out can be converted to structure before the data reduction processing is carried out. The file recipe can be efficiently managed by attaching the file recipe to content, and then storing the content in the media area 22.

In this example, the file recipe 52 includes a divided/not divided field T20, a pre-rearrangement offset column T21, a size column T22, a storage destination compression unit number column T23, an intra-storage destination compression unit offset/post-deduplicated data rearrangement offset column T24, and a deduplication destination column T25. Cells in the columns T21 to T25 on the same row construct one entry. One entry represents one data block in content. The same data amount reduction method is applied to each data block. The data block is constructed by, for example, one segment, a plurality of segments, or partial data in one segment.

The file recipe 52 further includes a compression unit number column T26, a post-compression application data offset column T27, an applied compression type column T28, a pre-compression size column T29, and a post-compression size column T30. Cells in the columns T26 to T30 on the same row construct one entry. Each entry indicates information on one compression unit. The compression unit is a data unit for which the compression processing is carried out after the rearrangement, and is an assembled segment group after the rearrangement processing and the deduplication processing or a non-assembled segment. For example, when the deduplication processing is applied to a part of an assembled segment after the rearrangement processing, remaining data of the assembled segment is a compression unit.

The divided/not divided field T20 indicates whether content after the rearrangement has been divided and then its data has been rearranged or its data has been rearranged without the division. In the example of FIG. 6, the content is divided, and the data rearrangement is then carried out for each divided portion. A file recipe is generated for each divided portion, and is attached to the head of the divided portion. The divided/not divided field T20 further indicates an offset of a position at which a next file recipe is stored when the data rearrangement is carried out for each divided portion.

The pre-rearrangement offset column T21 indicates an offset of a data block in content before the rearrangement. The size column T22 indicates a data length of each data block. The storage destination compression unit number column T23 indicates a number of a compression unit in which the data block is stored. The intra-storage destination compression unit offset/post-deduplicated data rearrangement offset column T24 indicates an offset in a compression unit storing a data block for which the deduplication processing is not carried out or an offset in content after the rearrangement of a data block for which the deduplication is carried out.

The deduplication destination column T25 indicates a reference destination data position of a data block to which the deduplication processing is applied. The reference destination is represented by a file name and an offset. In the example of FIG. 6, the deduplication processing is applied only to a top data block.

The compression unit number column T26 indicates a number of a compression unit. The compression unit number is sequentially assigned starting from a head compression unit in content after the rearrangement and the deduplication and before the compression. The post-compression application data offset column T27 indicates an offset in content of a compression unit after the compression. Thus, the position of the data block after the rearrangement is identified from the values in the storage destination compression unit number column T23 and the intra-storage destination compression unit offset/post-deduplicated data rearrangement offset column T24.

The applied compression type column T28 indicates a type of the data compression applied to the compression unit. The pre-compression size column T29 indicates the data size of the compression unit before the compression, and the post-compression size column T30 indicates the data size of the compression unit after the compression.

For example, a data block of a third entry includes a pre-rearrangement offset of 150 (B) and a data size of 100 B. This data block is stored at a position of an offset 102 (B) in the compression unit having a compression unit number of 4 in content after rearrangement and before the compression. In other words, the data block is data of 100 B from a position of the offset 102 (B) of a fourth compression unit from the head after the decompression processing of content stored in the media area 22.

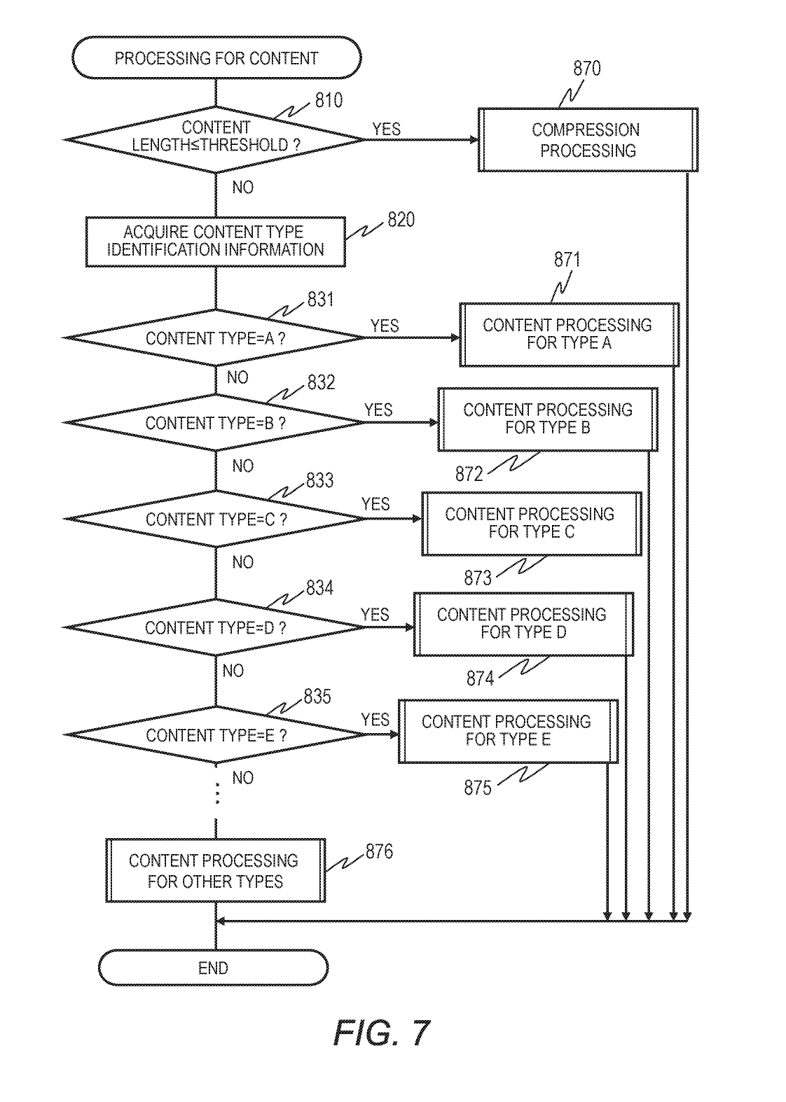

FIG. 7 is a flowchart for illustrating an outline of processing carried out for content by the file storage apparatus 14. The file storage apparatus 14 carries out this processing synchronously or asynchronously with content reception. For example, the file storage apparatus 14 temporarily stores the received content in the storage device 23, reads the content into the memory area 20 asynchronously with the content reception, and carries out this processing.

In Step 810, the content analysis program 30 determines whether or not the size of the entire content is equal to or less than a threshold. The content analysis program 30 acquires information on the content length from, for example, the management information in the content or a command received together with the content by the file storage apparatus 14.

When the content length is equal to or less than the predetermined threshold (YES in Step 810), in Step 870, the compression/decompression program 36 carries out the compression processing for the entire content. Data storage efficiency is not greatly increased by the data rearrangement processing for data small in size, and efficient processing can thus be implemented by omitting the data rearrangement processing. The deduplication may be applied to the content small in size.

When the content length is longer than the predetermined threshold (NO in Step 810), in Step 820, the content analysis program 30 refers to the content ID portion in the content to acquire information on the content type. The content ID portion exists at a specific position, for example, the head of the content, independently of the content structure, and the content analysis program 30 can thus identify the content ID portion in content having any structure. The content analysis program 30 may convert a value representing the content type acquired from the content ID portion to a value used only in the apparatus.

The file storage apparatus 14 then selects and carries out processing corresponding to the received content based on the information on the content type acquired in Step 820. In Step 831, the content analysis program 30 determines whether or not the content type of the received content is “A”.

When the content type is “A” (YES in Step 831), the content analysis program 30 proceeds to Step 871. In Step 871, the file storage apparatus 14 carries out processing prepared for content whose content type is “A”. When the content type is not “A” (NO in Step 831), the content analysis program 30 proceeds to Step 832. In Step 832, the content analysis program 30 determines whether or not the content type of the received content is “B”.

When the content type is “B” (YES in Step 832), the content analysis program 30 proceeds to Step 872. In Step 872, the file storage apparatus 14 carries out processing prepared for content whose content type is “B”. When the content type is not “B” (NO in Step 832), the content analysis program 30 proceeds to Step 833. In Step 833, the content analysis program 30 determines whether or not the content type of the received content is “C”.

When the content type is “C” (YES in Step 833), the content analysis program 30 proceeds to Step 873. In Step 873, the file storage apparatus 14 carries out processing prepared for content whose content type is “C”. When the content type is not “C” (NO in Step 833), the content analysis program 30 proceeds to Step 834. In Step 834, the content analysis program 30 determines whether or not the content type of the received content is “D”.

When the content type is “D” (YES in Step 834), the content analysis program 30 proceeds to Step 874. In Step 874, the file storage apparatus 14 carries out processing prepared for content whose content type is “D”. When the content type is not “D” (NO in Step 834), the content analysis program 30 proceeds to Step 835. In Step 835, the content analysis program 30 determines whether or not the content type of the received content is “E”.

When the content type is “E” (YES in Step 835), the content analysis program 30 proceeds to Step 875. In Step 875, the file storage apparatus 14 carries out processing prepared for content whose content type is “E”. When the content type is not “E” (NO in Step 835), the content analysis program 30 proceeds to the next content type determination step.

The file storage apparatus 14 carries out, for other content types, steps similar to the above-mentioned steps. The number of the content types for which processing specific thereto is prepared is limited. The content analysis program 30 sequentially determines the content type. When the content type of the received content does not match any of the content types defined in advance, the content analysis program 30 proceeds to Step 876. The processor 21 carries out processing prepared for other contents.

In each of Step 871 to Step 876 for the respective content types, the content analysis program 30 passes the content and the analysis result of the content to the data rearrangement program 32. The data rearrangement program 32 refers to the content processing information 50, and carries out the data rearrangement processing for the content in accordance with the method defined in advance for the content type.

After the rearrangement, the deduplication program 34 and the compression/decompression program 36 refer to the content processing information 50, and respectively carry out the deduplication processing and the compression processing for the content after the rearrangement in accordance with the methods defined in advance for the content types. Then, the content is stored in the media area 22, and this flow is finished.

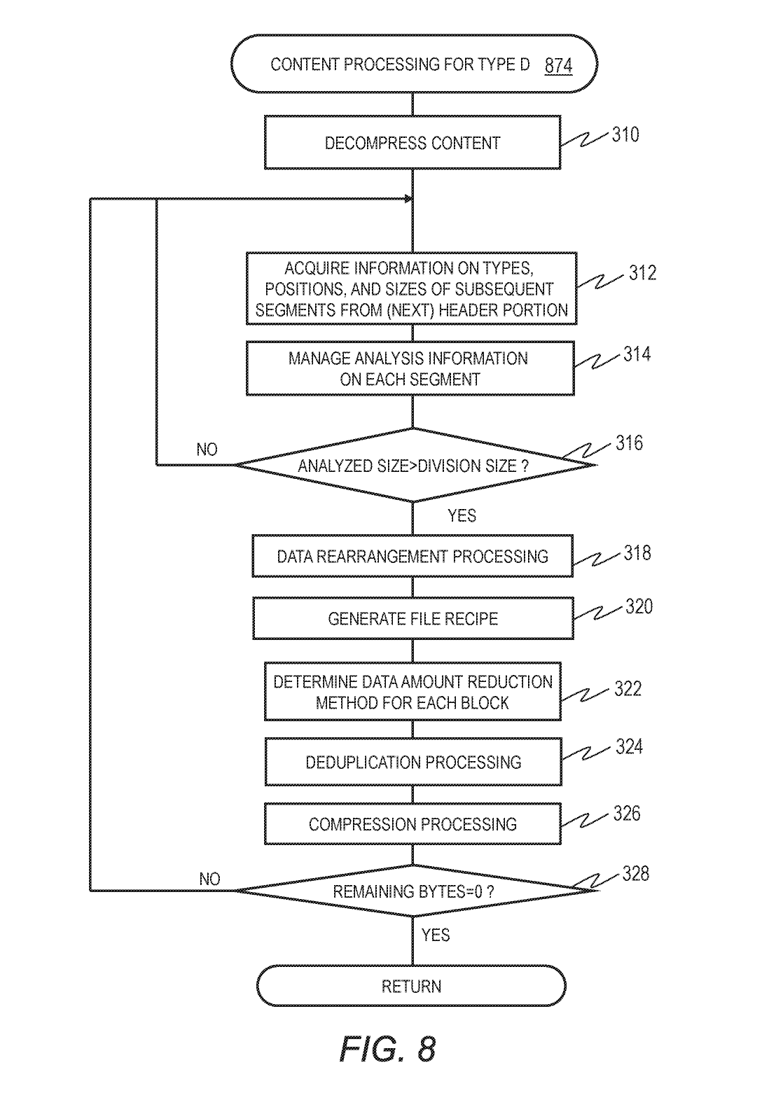

FIG. 8 is a flowchart for illustrating in detail Step 874 of the flowchart illustrated in FIG. 7, namely, the processing for the content whose content type is D. The content example 130 of the content type D is illustrated in FIG. 4D.

The content analysis program 30 acquires the information on the content type from the content ID portion 131. The processing in Step 874 is carried out after the content analysis program 30 determines the content type. In Step 873, the file storage apparatus 14 (processor 21) carries out the processing while assuming that the content type of the subject content is “D”. In the following, referring to the flowchart of FIG. 8, a description is given of an example of the conversion of the content D (130) illustrated in FIG. 4D to the content D′ (240) illustrated in FIG. 5C.

The content analysis program 30 refers to the decompression column T11 of the content processing information 50 to decompress the content depending on necessity (Step 310). Then, the content analysis program 30 refers to the structure information on the header portion H0 (132) in the content structure information 51 to acquire the structure information on the subsequent segments from the header portion H0 (132) (Step 312). The header portion H0 (132) includes the information on the type, the position (offset), and the data length of the body portion D0 (133), and the type, the position (offset), and the data length of the header portion H1 (134).

The header portion H0 (132) indicates that the body portion D0 (133) is the sub-content. The content analysis program 30 analyzes the body portion D0 (133). The content analysis program 30 refers to the content ID portion ID1 of the body portion D0 (133) to determine the content type of the sub-content 0. The content analysis program 30 determines the types, the positions (offsets), and the sizes of the respective segments of the sub-content 0.

The content analysis program 30 temporarily holds and manages an analysis result in the memory area 20 (Step 314). The analysis result includes the pre-rearrangement offsets, the sizes, the post-rearrangement offsets, and the segment types of the respective segments. On this occasion, the analysis result includes, in addition to information on the types, the positions, and the sizes of the content ID portion 131 and the header portion H0 (132), information on the types, the positions, and the sizes of the respective segments acquired from the analysis of the body portion D0 (133).

The content analysis program 30 refers to the content processing information 50 to determine whether or not the analyzed data size is larger than the division size indicated by the division size column T10 (Step 316). When the analyzed data size is equal to or less than the division size (NO in Step 316), the content analysis program 30 returns to Step 312.

In this example, the analyzed data size is equal to or less than the division size (NO in Step 316), and hence the content analysis program 30 acquires the structure information on the subsequent segments from the next header portion H1 (134). The content analysis program 30 specifically acquires information on the types, the positions, and the sizes of the body portion D1 (135) and the header portion H2 (136) (Step 312).

Further, the content analysis program 30 analyzes the body portion D1 (135). The content analysis program 30 adds the structure information on the header portion H1 (134) and the body portion D1 (135) to the analysis result stored in the memory area 20 (Step 314).

The content analysis program 30 determines whether or not the analyzed data size is larger than the division size (Step 316). In this example, the analyzed data size is larger than the division size (YES in Step 316). The data rearrangement program 32 carries out the data rearrangement processing in the analyzed data in accordance with an instruction from the content analysis program 30 (Step 318).

The data rearrangement program 32 refers to the analysis result of the analyzed data temporarily stored in the memory area 20 to carry out the data rearrangement processing in the analyzed data. The data rearrangement program 32 assembles segments of the same type in the analyzed data. The rearranged data is data acquired by removing the file recipe 242 from the divided portion 241 after the rearrangement of FIG. 5C.

The data rearrangement program 32 selects analyzed data from, for example, the content D (130). The data rearrangement program 32 changes the sequence of the segments so as to assemble the segments of the same type in the selected data. The data rearrangement program 32 stores the rearranged data for which the segment sequence is changed in another area of the memory area 20. The data rearrangement program 32 temporarily holds information on the type, the position (offset), and the size of each segment of the rearranged data in the memory area 20.

Then, the data rearrangement program 32 generates the file recipe 242 for the rearranged divided portion 241 (Step 320). The data rearrangement program 32 stores values in the divided/not divided field T20, the pre-rearrangement offset column T21, and the size column T22 of the file recipe 242 based on the analysis result before the rearrangement. On this occasion, the block of each entry is assumed to correspond to one segment.

Then, the data rearrangement program 32 determines the data amount reduction method for each block in the file recipe 242 (Step 322). The data rearrangement program 32 refers to the entry for the content type D in the content processing information 50 to determine the data reduction method for each segment type. The data amount reduction method for each segment is stored in the memory area 20. The data rearrangement program 32 stores a relationship between each block and the data reduction method in the memory area 20.

Then, the deduplication program 34 carries out the deduplication processing in accordance with an instruction from the content analysis program 30 (Step 324). The deduplication program 34 acquires, from the memory area 20, the information on the blocks (segments) determined in Step 322 to apply the deduplication processing, and carries out the deduplication processing in each applicable block.

The deduplication program 34 carries out deduplication determination by using a fixed length division, a variable length division, division of data on a file-to-file basis, and fingerprint (for example, Hash) calculation, binary comparison, or a combination of the fingerprint and the binary comparison, or the like. When the deduplication is determined to be carried out for a specific block, the deduplication program 34 deletes this block. The deduplication program 34 further stores the value of an offset after the rearrangement of the deleted data in the intra-storage destination compression unit offset/post-deduplicated data rearrangement offset column T24, and updates the deduplication destination column T25 with reference information on the deduplication destination.

In this example, the deduplication program 34 determines the deduplication for the entire data block of the entry of the file recipe 242. The deduplication program 34 may determine the deduplication for partial data in the entry. When the deduplication determination is made for partial data, the one cell of the deduplication destination column T25 may include a plurality of references. Moreover, the intra-storage destination compression unit offset/post-deduplicated data rearrangement offset column T24 also indicates the size of the deleted data. A pointer indicating the deduplication destination may be stored at a head position of the deleted data in addition to or in place of the information on the deduplication destination of the file recipe 242.

Then, the compression/decompression program 36 carries out the compression processing in accordance with an instruction from the content analysis program 30 (Step 326). The compression/decompression program 36 determines the compression unit in the content after the rearrangement and the deduplication. The compression/decompression program 36 determines continuous segments of the same type as one compression unit. The compression/decompression program 36 assigns serial numbers starting from a compression unit at the head, and stores values in the compression number column T26 and the pre-compression size column T29 of the file recipe 242.

The compression/decompression program 36 acquires the information on the compression processing application block (segment) determined in Step 322 from the memory area 20. The compression processing is carried out for the compression unit including the compression application blocks. The compression/decompression program 36 may determine a compression algorithm depending on the segment type. When the size of the data after the application of the compression is larger than that of the original data, the compression/decompression program 36 employs the original data.

The compression/decompression program 36 stores the information on the compression processing for each compression unit in the file recipe 242. Specifically, the compression/decompression program 36 stores the information on each compression unit in the post-compression application data offset column T27, the applied compression type column T28, and the post-compression size column T30.

Then, the content analysis program 30 determines whether or not data that has not been analyzed remains (Step 328). When unanalyzed data remains (NO in Step 328), the content analysis program 30 returns to Step 310. The content analysis program 30 repeats this flow. When no unanalyzed data remains (YES in Step 328), the content analysis program 30 finishes this flow.

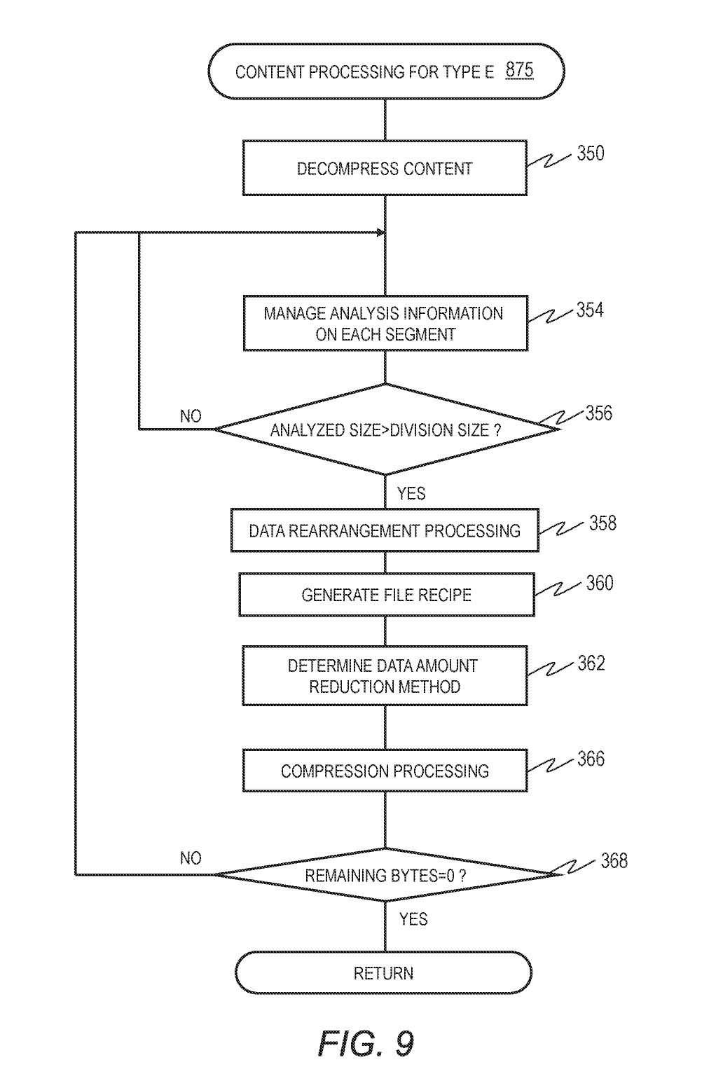

FIG. 9 is a flowchart for describing in detail Step 875 illustrated in FIG. 7, namely, the processing for the content whose content type is E. The content example 140 of the content type E is illustrated in FIG. 4E. The content 140 is the content written in accordance with a specific rule, for example, a log file.

The content analysis program 30 acquires the information on the content type from the content ID portion. The processing in Step 874 is carried out after the content analysis program 30 determines the content type. In Step 874, the file storage apparatus 14 (processor 21) carries out the processing while assuming that the content type of the subject content is “E”.

Step 350 is the same as Step 310 of the flowchart illustrated in FIG. 8. Next, the content analysis program 30 analyzes the content 140 starting from data at the head, thereby determining the types, the positions, and the sizes of the segments. The segment is separated by the separator character (for example, comma), and the segment type is defined for each column. In the example of FIG. 4E, the segment types are Col. 0 to Col. 5. The content analysis program 30 stores an analysis result of the segment in the memory area 20 (Step 354).

Then, the content analysis program 30 determines whether or not the size of the analyzed data is larger than the division size indicated by the content processing information 50 (Step 356). When the size of the analyzed data is equal to or less than the division size (NO in Step 356), the content analysis program 30 returns to Step 354.

When the size of the analyzed data is larger than the division size (YES in Step 356), the data rearrangement program 32 carries out the data rearrangement processing in the analyzed data in accordance with the instruction from the content analysis program 30 (Step 358). When the division size is not defined, or the content size is equal to or less than the division size, after all the segments of the content are analyzed, the data rearrangement processing (Step 358) is carried out for the entire content, which is the analyzed data.

The data rearrangement program 32 selects analyzed data from the content E (140). The data rearrangement program 32 changes the sequence of the segments so as to assemble the segments of the same column in the selected data. The data rearrangement program 32 stores the rearranged data in which the segment sequence is changed in another area of the memory area 20. The data rearrangement program 32 temporarily holds information on the type, the position (offset), and the size of each segment of the rearranged data in the memory area 20.

Then, the data rearrangement program 32 generates the file recipe 242 for the rearranged data (Step 360). The data rearrangement program 32 stores values in the divided/not divided field T20, the pre-rearrangement offset column T21, and the size column T22 of the file recipe 242 based on the analysis result before the rearrangement. On this occasion, the block of each entry is assumed to correspond to one segment.

Then, the data rearrangement program 32 determines the data amount reduction method for each column (Step 362). The data rearrangement program 32 refers to the entry for the content type E in the content processing information 50 to determine the data reduction method for each segment type (each column). In this example, it is assumed that the deduplication processing is not applied, and predetermined compression processing is applied to each predetermined column. Information on whether or not to apply the compression processing and the applied compression method are stored in the memory area 20 for each column.

Then, the compression/decompression program 36 carries out the compression processing in accordance with an instruction from the content analysis program 30 (Step 366). The compression/decompression program 36 determines a compression unit. The compression unit is an assembled segment group of each column. The compression/decompression program 36 assigns serial numbers starting from a compression unit at the head, and stores values in the compression number column T26 and the pre-compression size column T29 of the file recipe 242.

The compression/decompression program 36 acquires the information on the compression method for each column determined in Step 362 from the memory area 20. The compression processing is carried out for the assembled segment group of each column. The compression/decompression program 36 may determine the compression algorithm depending on the column. When the data after the application of the compression is larger than the original data, the compression/decompression program 36 employs the original data.

The compression/decompression program 36 stores the information on the compression processing for each compression unit in the file recipe 242. Specifically, the compression/decompression program 36 stores the information on each compression unit in the post-compression application data offset column T27, the applied compression type column T28, and the post-compression size column T30.

Then, the content analysis program 30 determines whether or not data that has not been analyzed remains (Step 368). When unanalyzed data remains (NO in Step 368), the content analysis program 30 returns to Step 310. The content analysis program 30 repeats this flow. When no unanalyzed data remains (YES in Step 368), the content analysis program 30 finishes this flow.

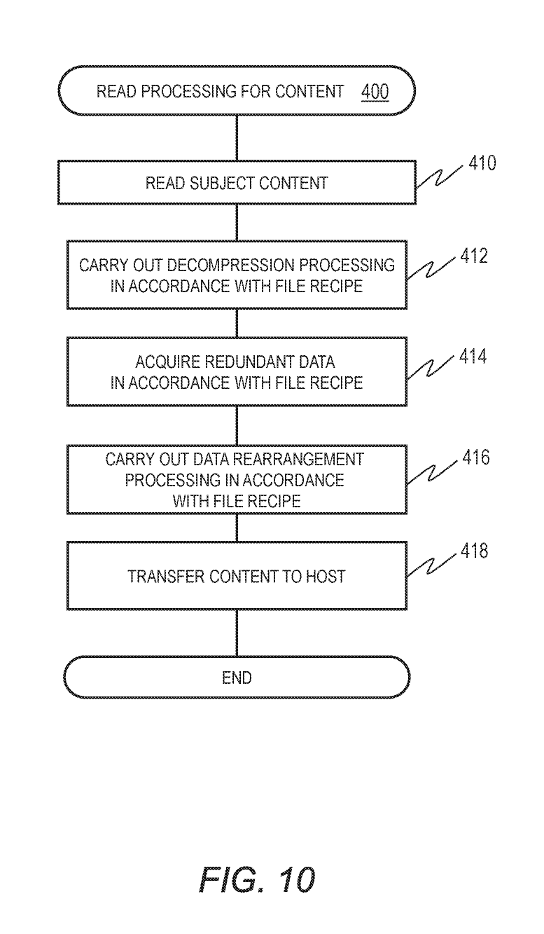

FIG. 10 is a flowchart for illustrating content read processing 400. A media I/O program (not shown) reads subject content from the media area 22 (Step 410). Then, the compression/decompression program 36 refers to the columns T26 to T30 of the file recipe to carry out the decompression processing for the compression unit (Step 412).

Then, the deduplication program 34 refers to the columns T24 and T25 of the file recipe to acquire data in a deduplicated block from the deduplication destination, and stores the data in the content (Step 414). Then, the data rearrangement program 32 refers to the columns T21 to T24 of the file recipe to rearrange the data for each block (Step 416).

As a result of the processing in Steps 412, 414, and 416, the content having data structure stored by the host is restored. The file storage apparatus 14 transfers the restored content to the host (Step 418). With the above-mentioned steps, the content having the data structure stored by the host can be returned to the host.

According to this embodiment, the data amount reduction processing is carried out after the data rearrangement processing for assembling segments of the same type, and hence the data amount of content can effectively be reduced. The information on the data amount reduction method may be stored in a place different from a file recipe. The content processing according to this embodiment can be applied to a storage apparatus having different structure from the file storage apparatus.

The segment type is a type defined in the file storage apparatus, and may be different from a segment type in another definition. The file storage apparatus may assemble segments of a part of the segment types.

### Second Embodiment

In a second embodiment of this invention, a description is given of a file storage apparatus constructed by a file storage head 64 and a block storage apparatus 70. The file storage head 64 and the block storage apparatus 70 cooperate with each other to carry out the processing described in the first embodiment. A description is now given mainly of differences from the first embodiment.

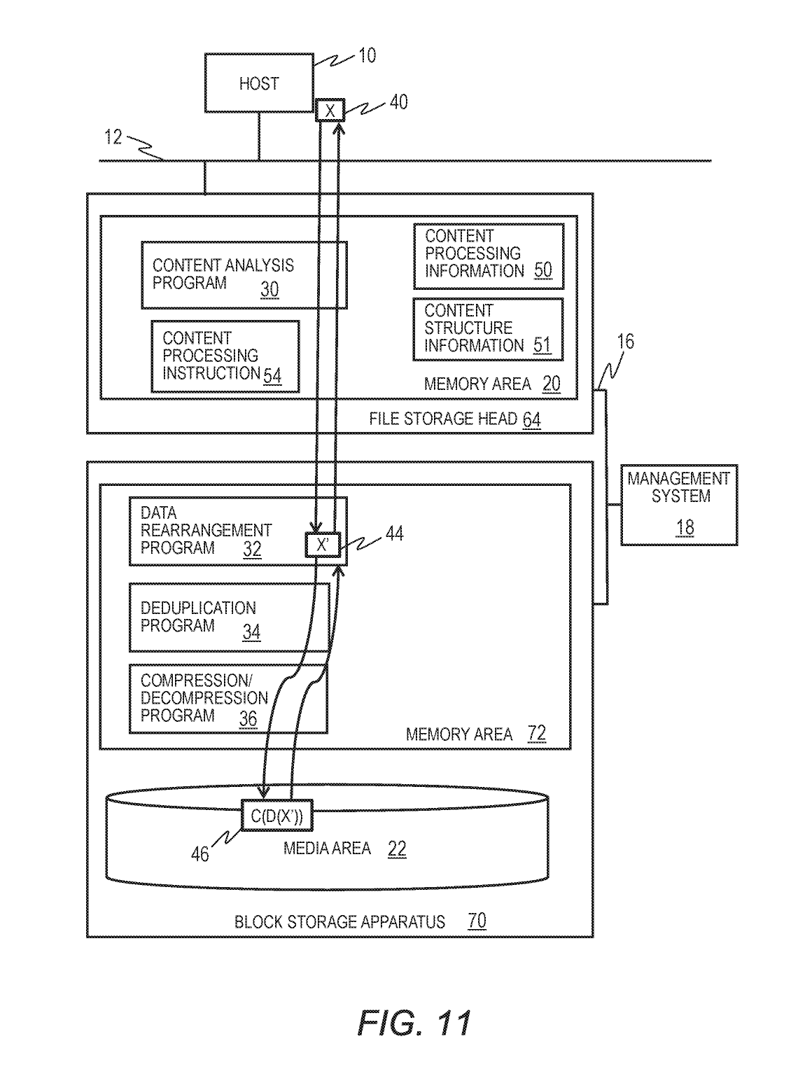

FIG. 11 is a diagram for schematically illustrating this embodiment. The memory area 20 of the file storage head 64 stores the content analysis program 30. A memory area 72 of the block storage apparatus 70 stores the data rearrangement program 32, the deduplication program 34, and the compression/decompression program 36.

The host 10 transmits to the file storage head 64 the content X 40 together with an update request. The content analysis program 30 analyzes the content X 40 in accordance with the content processing information 50 and the content structure information 51.

The content analysis program 30 generates a content processing instruction 54, and transmits the content processing instruction 54 together with the content X 40 to the block storage apparatus 70. The block storage apparatus 70 carries out the data rearrangement processing, the deduplication processing, and the compression processing for the content X 40 in accordance with the content processing instruction 54, and stores the content X 40 in the media area 22.

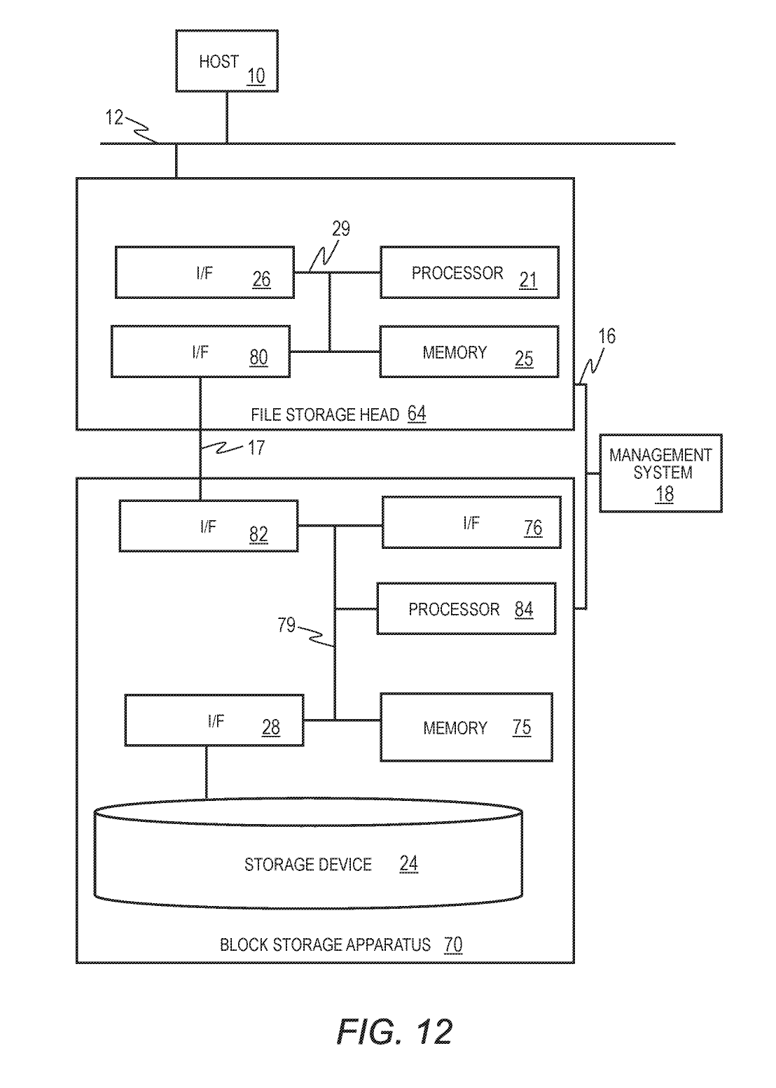

FIG. 12 is a diagram for illustrating a hardware configuration example of the file storage head 64 and the block storage apparatus 70. The file storage head 64 and the block storage apparatus 70 are configured to communicate to/from each other via the one management system 18 and the management network 16. The file storage head 64 and the block storage apparatus 70 are coupled to each other via the data network 17. The data network 17 is, for example, a SAN.

The file storage head 64 is coupled to the data network 17 via an I/F 80. The block storage apparatus 70 is coupled to the data network 17 via an I/F 82, and is configured to communicate to/from the management system 18 via an I/F 76. The block storage apparatus 70 includes a processor 84. The processor 84 operates in accordance with various programs including the data rearrangement program 32, the deduplication program 34, and the compression/decompression program 36 stored in the memory 75, thereby implementing predetermined functions.

The processor 21 and the memory 25 are an example of a controller of the file storage head 64, and the processor 84 and the memory 75 are an example of a controller of the block storage apparatus 70. At least a part of functions of the processors 21 and 84 may be implemented by other logic circuits.

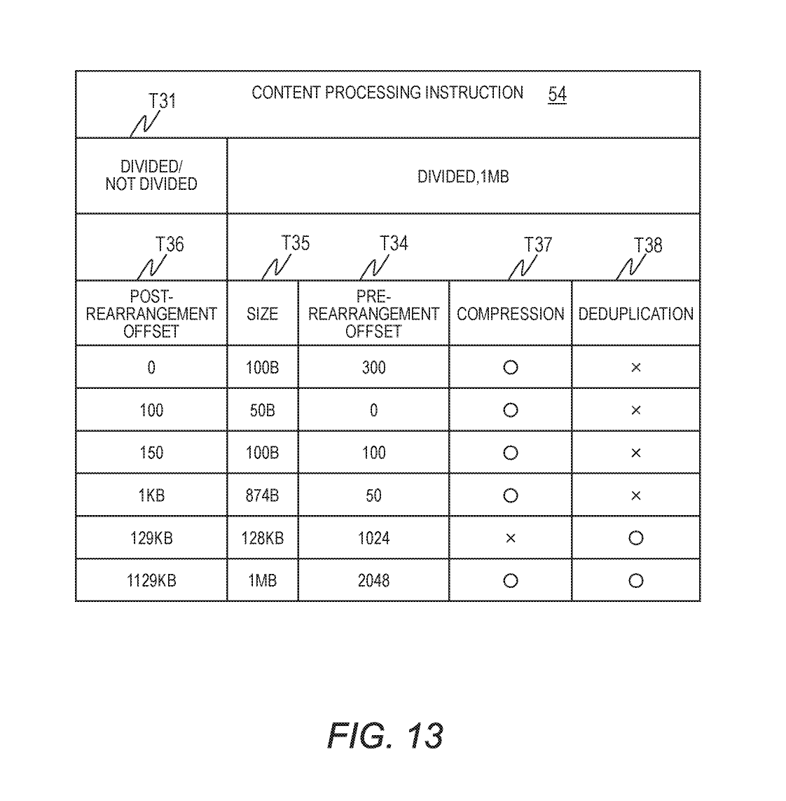

FIG. 13 is a diagram for illustrating an example of the content processing instruction 54. The content processing instruction 54 includes the same structure as that of the file recipe. Specifically, the content processing instruction 54 includes a divided/not divided field T31, a post-rearrangement offset column T36, a size column T35, a pre-rearrangement offset column T34, a compression column T37, and a deduplication column T38.

The content analysis program 30 generates the content processing instruction 54 based on the content type of received content, the content processing information 50, and the content structure information 51 in the same way as that of generating the file recipe described in the first embodiment. When the content is divided into a plurality of portions, the content processing instruction 54 is generated for each of the divided portions. For example, a sequence number in accordance with a sequence of the divided portions before the rearrangement is assigned to each content processing instruction 54.

The divided/not divided field T31 indicates whether or not the division before the rearrangement is to be carried out. When the division is to be carried out, the divided/not divided field T31 further indicates a division size. The content analysis program 30 compares the content size and a prescribed division size with each other, and when the content size is larger than the prescribed division size, determines to divide the content into a plurality of portions each having the division size or less. The determination of each divided portion is as described above referring to the flowchart of FIG. 8.

The post-rearrangement offset column T36 indicates an offset of each block after the rearrangement. The size column T35 indicates a data length of each block. The pre-rearrangement offset column T34 indicates an offset of each block before the rearrangement. The content analysis program 30 determines the rearrangement destination of each block by the same method as that of the data rearrangement processing carried out by the data rearrangement program 32 according to the first embodiment.

The compression column T37 and the deduplication column T38 respectively indicate whether or not the compression and the deduplication are to be applied to each block. The content analysis program 30 determines the data amount reduction method for each block by the method described in the first embodiment, and stores information on the data amount reduction method in the compression column T37 and the deduplication column T38.

In the block storage apparatus 70, the data rearrangement program 32, the deduplication program 34, and the compression/decompression program 36 each carry out processing for the content in accordance with the content processing instruction 54. When a plurality of content processing instructions 54 exist for content, the block storage apparatus 70 carries out processing for each portion indicated by the content processing instruction 54.

The data rearrangement program 32 refers to the divided/not divided field T31, and when the divided/not divided field T31 indicates “divided”, carries out the data rearrangement for data of the size indicated by the divided/not divided field T31. The data rearrangement program 32 rearranges a block of each entry in the content processing instruction 54 to a position indicated by the post-rearrangement offset column T36.

The deduplication program 34 selects a block to which the application of the deduplication processing is indicated by the content processing instruction 54 for the data to which the rearrangement processing has been applied, and carries out the deduplication processing for the block. The deduplication processing may be the same as that of the first embodiment. The deduplication program 34 stores a pointer indicating the deduplication destination in the content, or in the content processing instruction 54.

The compression/decompression program 36 carries out the compression processing for the data to which the deduplication processing has been applied. The compression/decompression program 36 selects a block to which the application of the compression processing is indicated by the content processing instruction 54, and carries out the compression processing for the block. The compression processing may be the same as that of the first embodiment.

The content processing instruction 54 is stored together with content in the media area 22. When content is read, the data rearrangement program 32, the deduplication program 34, and the compression/decompression program 36 refer to the content processing instruction 54 to process the content. Data processing by each of the programs for reading the content is the same as that described in the first embodiment for reading content.

According to this embodiment, the file storage head 64 carries out the content analysis, and the block storage apparatus 70 carries out the data rearrangement processing and the data amount reduction processing, thereby enabling a decrease in load imposed on the file storage head 64, and an increase in performance of the entire file storage apparatus.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

The drawings shows control lines and information lines as considered necessary for explanations but do not show all control lines or information lines in the products. It can be considered that almost of all components are actually interconnected.

What is claimed is:

1. A storage apparatus, comprising:
a controller configured to carry out data processing for content that is received; and
a media area configured to store the content for which the data processing has been carried out,
wherein the controller is configured to:
classify segments in the content;
carry out data rearrangement processing of assembling segments of the same type in the classified segments;
carry out data amount reduction processing for the content for which the data rearrangement processing has been carried out; and
store in the media area the content for which the data amount reduction processing has been carried out.

2. The storage apparatus according to claim 1, wherein the controller is configured to:
hold, in advance, content processing information for associating a segment type in the content and a data amount reduction method with each other; and
determine a data amount reduction method for each of the segments based on a segment type of the each of the segments and the content processing information.

3. The storage apparatus according to claim 2, wherein:
the content processing information associates the segment type and the data amount reduction method with each other for each of a plurality of content types; and
the controller is configured to acquire information on a content type of the received content from the content processing information.

4. The storage apparatus according to claim 2, wherein the controller is configured to store in the content processing information a relationship between a segment type in the content specified by a user and the data amount reduction method.

5. The storage apparatus according to claim 1, wherein the controller is configured to:
divide the content into a plurality of portions when a size of the content is larger than a prescribed size; and
carry out the data rearrangement processing and the data amount reduction processing for each of the plurality of portions.

6. The storage apparatus according to claim 1, wherein the controller is configured to:
generate a recipe representing a data position relationship between before and after the data rearrangement processing in the content; and
store in the media area the content to which the recipe is attached.

7. The storage apparatus according to claim 1, wherein when data of the received content is compressed, the controller decompresses the received content, and then carries out the data rearrangement processing.

8. The storage apparatus according to claim 1, further comprising:
a storage head comprising a first controller; and
a block storage apparatus comprising a second controller and the media area, wherein:
the controller comprises the first controller and the second controller;
the first controller is configured to analyze the content, thereby generating a content processing instruction for specifying a data position relationship between before and after the rearrangement, and the data amount reduction method; and
the second controller is configured to:
receive the content and the content processing instruction from the storage head;
carry out the data rearrangement processing and the data amount reduction processing for the content in accordance with the content processing instruction; and
store the content in the media area.

9. A method of storing content in a storage apparatus, the method comprising:
receiving content;
classifying segments in the content that is received;
carrying out data rearrangement processing of assembling segments of the same type in the classified segments;
carrying out data amount reduction processing for the content for which the data rearrangement processing has been carried out; and
storing in a media area the content for which the data amount reduction processing has been carried out.

10. The method according to claim 9, wherein the data amount reduction processing comprises determining a data amount reduction method for each of the segments based on a segment type of the each of the segments and content processing information for associating a segment type in the content and a data amount reduction method with each other.

11. The method according to claim 10, wherein the content processing information associates the segment type and the data amount reduction method with each other for each of a plurality of content types.

12. The method according to claim 10, further comprising storing in the content processing information a relationship between a segment type in the content specified by a user and the data amount reduction method.

13. The method according to claim 9, further comprising dividing the content into a plurality of portions when a size of the content is larger than a prescribed size,
wherein the data rearrangement processing and the data amount reduction processing comprise carrying out the data rearrangement processing and the data amount reduction processing for each of the plurality of portions.

14. The method according to claim 9, further comprising generating a recipe representing a data position relationship between before and after the data rearrangement processing in the content,
wherein the storing comprises storing in the media area the content to which the recipe is attached.

15. The method according to claim 9, further comprising decompressing, when data of the received content is compressed, the received content before the data rearrangement processing.
